(19) United States
(12) Patent Application Publication
(10) Pub. No.: US 2005/0151297 A1
(43) Pub. Date: Jul. 14, 2005

(54) Transition metal and transition metal oxide glove and condom formers and coatings therefor

(76) Inventor: Tamer El-Raghy, Voorhees, NJ (US)

Correspondence Address: LICATLA & TYRRELL P.C., 66 E. MAIN STREET, MARLTON, NJ, 08053, US

(21) Appl. No.: 10/512,832

(22) PCT Filed: May 16, 2003
(86) PCT No.: PCT/US03/15606

Related U.S. Application Data
(60) Provisional application No. 60/381,723, filed on May 17, 2002.

(51) Int. Cl. B23K 1/00

(52) U.S. Cl. 264/219

(57) ABSTRACT

A glove or condom former made of or coated with one or more transition metals and/or transition metal oxides is provided that exhibits improved durability over glove and condom formers currently in use.

### FIELD OF THE INVENTION

The invention relates to glove and condom formers that are used in the manufacture of natural latex or synthetic polymer gloves and condoms. This invention further relates to glove or condom formers and coatings for glove and condom formers made of one or more transition metals and/or transition metal oxides.

### BACKGROUND OF THE INVENTION

Glove and condom formers are rigid molds sized and shaped to define the dimensions of the finished products. These formers are used to make gloves such as latex examination gloves and surgical gloves or condoms. The formers are typically made of ceramic, porcelain, plastic, steel or aluminum, and are dipped, usually fingers first in the case of a glove former into a liquid latex bath, including admixed chemicals, where the latex adheres to the former. The glove or condom formers may be heated prior to beginning the dipping process. The latex is dried and the glove or condom is released from the former usually by peeling the glove or condom from the glove or condom from the former and inverting the article in the process. The articles may be removed from the former in water.

After repeated cycles of chemical dips such formers begin to degrade and must be replaced. Glove and condom formers are usually pre-coated with a coagulant to gel the latex and to facilitate removal of the article from the former. Typical coagulants include calcium nitrate. Additional dips in latex baths that contain fillers may also be required. As a benchmark for durability, porcelain formers remain in good condition for up to two weeks when exposed to a concentrated solution of potassium hydroxide. The gloves or condoms may also go through leaching and washing cycles to remove residual chemicals before being stripped from the former. The finished articles are then removed from the former such that the outer layer from the former will be the innermost layer of the glove or condom. The articles may then be sterilized and packaged for shipping.

There is a need for glove and condom formers of a durable material that will reduce the frequency with which the formers must be replaced. It is desirable that the durable formers do not otherwise interfere with the quality of the glove or condom produced.

### SUMMARY OF THE INVENTION

An object of the present invention is to provide a glove or condom former or a coating for a glove of condom former comprising one or more transition metals and/or transition metal oxides.

Another object of the present invention is to provide a method for producing gloves or condoms using a glove or condom former comprising one or more transition metals and/or transition metal oxides or coated with one or more transition metal and/or transition metal oxides.

### DETAILED DESCRIPTION OF THE INVENTION

The present invention provides glove and condom formers with enhanced durability as compared to ceramic, porcelain, plastic, steel or aluminum glove and condom formers currently in use.

In one embodiment of the present invention, the glove and condom formers comprise one or more transition metals and/or transition metal oxides. Examples of transition metals and transition metal oxides useful in the formers of the present invention include, but are not limited to, titanium, titanium oxides, titanium alloys, zirconium, zirconium alloys, zirconium oxide, niobium, niobium alloys, niobium oxides, tantalum, tantalum alloys, tantalum oxides, hafnium, hafnium alloys, hafnium oxides, chromium, chromium alloys, chromium oxides, molybdenum, molybdenum alloys and molybdenum oxides. Preferably, in this embodiment, the glove or condom former consists essentially of one or more of these transition metals and/or one or more transition metal oxides. More preferred is a glove or condom former comprising titanium, titanium oxide, zirconium and/or zirconium oxide.

Formers consisting essentially of transition metals and/or transition metal oxides can be produced by any commercially available powder forming technique such as, but not limited to, slip casting, gel casting, injection molding, solid free forming, or rapid prototyping, followed by sintering. For example, slip casting and sintering of one or more transition metals and/or transition metal oxides into a glove or condom former is conducted, by dispersing the transition metal or metals and/or transition metal oxide or oxides in a solvent such as water along with a binder and viscosity modifying agent. The dispersion preferably ranges from about 25% to 85% solids. The binder and viscosity modifier are preferably cellulose-based materials. However, other organic or inorganic binders can also be used. The resulting dispersion or slurry is referred to as the slip. The slip is poured into a commercially available mold, preferably a plaster of paris mold, and allowed to set for up to five hours before the excess slip is drained. The former is removed from the mold and allowed to air dry. After drying, the former is heated in an oven at temperatures of 1000 C to 1500 C. This firing or heating is the sintering step.

In another embodiment of the present invention, coatings comprising one or more transition metals and/or transition metal oxides are provided for standard glove or condom formers or transition metal and/or transition metal oxide formers of the present invention. For purposes of the present invention, by “standard glove or condom former” it is meant a former comprising a known material for formers including, but not limited to, ceramic, porcelain, plastic, steel or aluminum. Examples of transition metals and/or transition metal oxides useful as coatings for this embodiment include, but are not limited to, titanium, titanium oxides, titanium alloys, zirconium, zirconium alloys, zirconium oxide, niobium, niobium alloys, niobium oxides, tantalum, tantalum alloys, tantalum oxides, hafnium, hafnium alloys, hafnium oxides, chromium, chromium alloys, chromium oxides, molybdenum, molybdenum alloys and molybdenum oxides. Preferably, in this embodiment, the coating consists essentially of one or more transition metals and/or transition metal oxides. Preferred transition metals and transition metal oxides for coating the former include titanium, titanium oxide, zirconium and zirconium oxide.

For application of the coating, it is preferred that one or more transition metals and/or transition metal oxides be mixed with a solvent such as water. A binding agent can also be added. For standard glove or condom formers, it is preferred that the transition metal coating be applied via thermal spraying in accordance with well known techniques such as plasma spraying or HVOF (high velocity oxyfuel). For transition metal or transition metal oxide formers, the coating is preferably applied following the powder formation technique, but prior to sintering. For example, if the transition metal and/or transition metal oxide former is formed by slip casting, the coating, prepared by mixing one or more transition metals and/or transition metal oxides with a solvent such as water, is preferably applied to the former by painting or atomizing prior to the sintering cycle.

Accelerated chemical resistance testing has been conducted to test the durability of titanium oxide (TiO₂) as a material for a solid former. One accelerated aging test was performed by immersing the titanium oxide sample in a 20% solution of potassium hydroxide at 170° F. The titanium oxide sample was removed on a periodic basis and evaluated. It was noted that after six (6) weeks of immersion, the sample did not show any measurable weight change or visible surface defects. In comparison, standard porcelain formers degrade after two weeks of exposure to potassium hydroxide as evidenced by pitting in the former and by producing gloves that have pinhole sized defects in the gloves. From these experiments, it is expected that transition metal and/or transition metal oxide oxides formers or formers coated with transition metals and/or transition metal oxides will exhibit improved durability on the order of 300%.

It should be understood that various changes and modifications to the embodiments described herein would be apparent to those skilled in the art. Such changes and modifications can be made without departing from the spirit and scope of the present invention and without demising the attendant advantages. It is, therefore, intended that such changes and modifications be covered by the appended claims.

1. A glove or condom former comprising one or more transition metals or transition metal oxides.

2. The glove or condom former of claim 1 consisting essentially of one or more transition metals or transition metal oxides.

3. The glove or condom former of claim 1 wherein the transition metal or transition metal oxide is selected from the group consisting of titanium, titanium oxides, titanium alloys, zirconium, zirconium alloy, zirconium oxide, niobium, niobium alloys, niobium oxides, tantalum, tantalum alloys, tantalum oxides, hafnium, hafnium alloys, hafnium oxides, chromium, chromium alloys, chromium oxides, molybdenum, molybdenum alloys and molybdenum oxides.

4. The glove or condom former of claim 1 wherein the transition metal or transition metal oxide is titanium, titanium oxides, zirconium, or zirconium oxides.

5. The glove or condom former of claim 1 further comprising one or more transition metals or transition metal oxides coating on the former.

6. A glove or condom former comprising a standard glove or condom former coated with a one or more transition metals or transition metal oxides.

7. The glove or condom former of claim 6 wherein the transition metal is selected from the group consisting of titanium, titanium oxides, titanium alloys, zirconium, zirconium alloy, zirconium oxide, niobium, niobium alloys/niobium oxides, tantalum, tantalum alloys, tantalum oxides, hafnium, hafnium alloys, hafnium oxides, chromium, chromium alloys, chromium oxides, molybdenum, molybdenum alloys and molybdenum oxides.

8. The glove or condom former of claim 6 wherein the standard former is coated with titanium, titanium oxides, zirconium, or zirconium oxide.
